(19) United States
(12) Patent Application Publication
(10) Pub. No.: US 2002/0095589 A1
(43) Pub. Date: Jul. 18, 2002

(54) Secure file transfer method and system

(76) Inventor: Winston Donald Keech, Whitby (GB)

Correspondence Address: GREENBERG-TRAURIG, 1750 TYSONS BOULEVARD, 12TH FLOOR, MCLEAN, VA, 22102, US

(21) Appl. No.: 09/994,919

(22) Filed: Nov. 28, 2001

(30) Foreign Application Priority Data
Nov. 28, 2000 (GB) 0028935.5

(51) Int. Cl. H04L 9/32

(52) U.S. Cl. 713/189

(57) ABSTRACT

A method and system for the secure transfer of data files from one computer to another. The data file is wrapped or encrypted within an executable file and may only be accessed again by unwrapping or decrypting the data file with a unique key code. The unique key code is effectively held in escrow until an intended recipient of the data file has verified his or her identity to a sender of the data file by way of various verification techniques.

### CROSS REFERENCE TO RELATED APPLICATION

The present application claims priority from UK patent application number 0028935.5, filed on Nov. 28, 2000 which is incorporated herein by reference in its entirety.

### FIELD OF THE INVENTION

The present invention relates to a method and system for confirming that an electronic data file downloaded from a remote computer server by way of the Internet, the World-Wide Web (the Web) or otherwise has been obtained from an authentic or authorised source. The invention also relates to a method and system for secure transfer of files from one computer to another, for example by way of the Internet or Web.

### BACKGROUND OF THE INVENTION

With the recent and rapid expansion of the Internet and the Web and other protocols for transferring large amounts of data between remote computers by way of telecommunications links and the like, it has now become increasingly easy to copy and transfer files containing video and audio recordings as well as many other software applications. Standard file formats such as MP3, MPEG, JPEG and many more allow high quality digital audio and video recordings to be downloaded for very little, if any, cost and to be played back at any convenient time, possibly by way of portable units such as pocket MP3 players. While these developments are readily welcomed by consumers, it is very difficult to enforce copyright in audio and video recordings when these can be downloaded so easily, and this can result in a significant loss of revenue to the companies that make and release these recordings, as well as to the authors and performers of the recorded works. Traditionally, audio and video recordings have been sold to the public in the form of data carriers such as compact discs and the like, the distribution of which was heretofore relatively easy to control. This is no longer the case, and there is consequently a need to provide some form of control over the distribution of authentic recordings.

The problem is compounded by the fact that many data files which can be downloaded by a consumer at no cost from potentially inauthentic sources may contain viruses, worms or Trojan horses (“Trojans”) which can infect and disrupt the consumer's computer or network. This can have devastating and expensive consequences, and is a high price to pay just to obtain free data files.

It is apparent that there is a need to provide a method and system for the secure transfer of data files from authentic sources, whereby a data file provider can provide an assurance to consumers that the data files thus provided are free of viruses and Trojan horses. Furthermore, there is a need to provide some way of raising revenue for the data file provider and the authors and performers of the works provided by the data file provider.

Moreover, there is an increasing need for files of any description, such as text files, spreadsheets, graphics and many others, to be securely transferred from one authorised user to another by way of a public network such as the Internet or Web. Currently, the most secure file transfer protocols make use of public-key encryption techniques, but these require the exchange of public keys between a person sending a file and a person receiving a file. Specifically, if a sender wants to transmit an encrypted file to a recipient, the sender must know the recipient's public key. It is therefore difficult to send copies of the file to multiple recipients, and impossible to send a file to a recipient with whom the sender has not previously exchanged public keys. More importantly, public key encryption provides no security from an unauthorised third party with access to the intended recipient's computer, since there is no verification of the identity of the operator of that computer, merely of the identity of the computer itself (and any private key stored therein).

### BRIEF SUMMARY OF THE INVENTION

Improved systems and methods for electronically verifying an identity of a user by way of applying a mask code to a pseudo-random security string so as to generate a volatile one-time identification code are described in the present applicants' co-pending patent applications GB 0021964.2, PCT/GB01/04024, U.S. Ser. No. 09/663,281, U.S. Ser. No. 09/915,271 and U.S. Ser. No. 09/982,102, the full disclosures of which are hereby incorporated into the present application by reference. In these systems and methods, a user is assigned a personal identification number (PIN) comprising a numerical string which, initially at least, is automatically assigned by a computer in a pseudo-random manner without the PIN becoming known to any person other than the user, as is well known in the art. This PIN is the mask code, and is known only to the user and to a secure remote server operated by an authentication body or agency (but not to employees of the authentication body or agency), and the PIN or mask code is only ever transmitted from the authentication body or agency to the user by mail or other secure means upon first registration of the user with the authentication body or agency. If the user needs to verify his or her identity to a third party, the third party requests the authentication body or agency to cause the secure remote server to transmit a pseudo-random string to the user, and the user then applies the mask code to the pseudo-random string in accordance with predetermined rules so as to generate a volatile one-time identification code. The volatile one-time identification code may be generated by selecting characters from the pseudo-random string on a positional basis by taking each digit of the mask code in turn and applying it to the pseudo-random string. For example, a PIN or mask code “5724” may be applied to the pseudo-random string to return a volatile one-time identification code comprising the fifth, seventh, second and fourth characters taken from the pseudo-random string. The volatile one-time identification code is then transmitted by the user back to the remote server, where it is compared with an identification code calculated in the same way at the remote server, since the remote server has knowledge of the user's PIN and the pseudo-random string. If the two identification codes match, then the user is determined to have been positively identified. The prime security feature is that the mask code is never transmitted between the user and any other party by way of a telecommunications link which is vulnerable to data interception, and is thus safe from interception by unauthorised third parties.

It will be apparent that the pseudo-random string as described above must be at least ten characters long, since a mask code made up of the numbers 0 to 9 requires at least ten positions along the identification string to be functional. However, a person of ordinary skill will appreciate that different mask codes and string lengths may be used as required by selecting appropriate coding schemas.

According to a first aspect of the present invention, there is provided a method of transferring a data file having a file name from a first computer operated by a first user to a second computer operated by a second user, under control of a third computer, comprising the steps of:

i) in the first computer, the first user selecting a data file for transfer and establishing a communications link with the third computer;

ii) verifying an identity of the first user to the third computer by way of verification communications between the first and third computers;

iii) in the first computer, wrapping or encrypting the data file within an executable file adapted to unwrap or decrypt the data file only upon activation by a unique key code, and then transmitting the executable file containing the wrapped or encrypted data file directly to the second computer together with first user identification information and the file name of the data file;

iv) transmitting the file name of the data file from the first computer to the third computer, together with first user identification information and the unique key code;

v) in the second computer, upon receipt of the executable file containing the wrapped or encrypted data file and upon attempted access thereto by the second user, establishing a communications link with the third computer;

vi) verifying an identity of the second user to the third computer by way of verification communications between the second and third computers;

vii) upon successful verification of the identity of the second user, transmitting the file name of the data file from the second computer to the third computer with a request for the unique key code; and

viii) transmitting the unique key code from the third computer to the second computer so as to cause the executable file to unwrap or decrypt the data file and to allow access thereto in the second computer by the second user.

According to a second aspect of the present invention, there is provided a secure data transfer system comprising a first computer operated by a first user, a second computer operated by a second user and a third computer, the system being adapted to transfer a data file having a file name from the first computer to the second computer under control of the third computer, in which:

i) the first computer is adapted to establish a communications link with the third computer upon selection by the first user of a data file for transfer;

ii) the first and third computers are adapted to verify an identity of the first user to the third computer by way of verification communications between the first computer and the third computer;

iii) the first computer is adapted to wrap or encrypt the data file within an executable file adapted to unwrap or decrypt the data file only upon activation by a unique key code, and to transmit the executable file containing the wrapped or encrypted data file directly to the second computer together with first user identification information and the file name of the data file;

iv) the first computer is adapted to transmit the file name of the data file from the first computer to the third computer, together with first user identification information and the unique key code;

v) the second computer is adapted, upon receipt of the executable file containing the wrapped or encrypted data file and upon attempted access thereto by the second user, to establish a communications link with the third computer;

vi) the second and third computers are adapted to verify an identity of the second user to the third computer by way of verification communications between the second computer and the third computer;

vii) the second computer is adapted, upon successful verification of the identity of the second user, to transmit the file name of the data file from the second computer to the third computer with a request for the unique key code; and

viii) the third computer is adapted to transmit the unique key code from the third computer to the second computer so as to cause the executable file to unwrap or decrypt the data file and to allow access thereto in the second computer by the second user.

For the avoidance of doubt, the expressions “first computer” and “second computer” are not to be understood as being limited to first and second stand-alone computer devices, but are intended to encompass first and/or second computer networks, such as local or wide area networks and the like, as well as portable computers such as personal digital assistants and third (or subsequent) generation mobile telephones or communicators. The “third computer” will generally be a remote server, but may also comprise a computer network. Because the “third computer” will generally include a database of subscribers and transaction records, the technology available at the filing date of the present invention means that the “third computer” will generally be a standard server, LAN or WAN, or even a mainframe computer or the like. However, given the rapid technological advances currently being made in this field, there is no reason why the “third computer” may not one day be in the form of a portable computer as hereinbefore defined.

The identity of the first user may be verified in steps ii) above by way of the third computer transmitting a pseudo-random security string to the first computer, the first user applying a first user mask code to the pseudo-random security string so as to generate a first user volatile identification code, the first user transmitting the first user volatile identification code to the third computer and the third computer comparing the first user volatile identification code with a first check volatile identification code obtained by applying the first user mask code to the pseudo-random string in the third computer, identity verification taking place when the first user volatile identification code and the first check volatile identification codes are found to match each other. Instead of the pseudo-random security string being generated initially by the third computer and transmitted to the first computer, the pseudo-random string may be generated automatically in the first computer and sent to the third computer together with the first check volatile identification code generated by applying the first user mask code to the pseudo-random string. The first user may have a unique permanent first user identification code which is known to the first user and to the third computer, and may also be publicly known, and which allows correlation in the third computer of all information associated with the identity of the first user.

The identity of the second user may be verified in steps vi) above in a similar manner, using a second user mask code. The second user mask code may be applied for verification purposes to the same pseudo-random string as sent to the first user from the third computer or generated in the first computer, in which case the pseudo-random string is associated with the data file in the first computer upon wrapping or encryption of the data file within the executable file and transmitted to the second computer therewith in step iii) above, and also to the third computer in step iv) above. Alternatively, an independent pseudo-random string may be generated in the third computer and independently transmitted to the second computer to start the verification process for the second user. The second user may have a unique permanent second user identification code which is known to the second user and to the third computer, and may also be publicly known, and which allows correlation in the third computer of all information associated with the identity of the second user.

A particularly preferred method of verifying the identities of the first and/or second users to the third computer employs a graphical interface as described in the present applicant's co-pending patent applications U.S. Ser. No. 09/915,271, U.S. Ser. No. 09/982,102 and PCT/GB01/04024. For example, where the identity of the first user needs to be verified to the third computer, there is provided a secure user code entry interface which is stored in and runs on the first computer, the interface including at least one active display which is displayed on a monitor or the like of the first computer. The at least one active display allows for entry, by the first user, of one digit of a PIN or mask code per cycle of the interface. The active display of the interface illuminates or highlights at least one display digit on the interface and the user keys any key of a keypad or mouse or touches any area of a touch sensitive screen or responds through any other user input device when the illuminated or highlighted digit matches the digit to be entered in his or her user code. A random run on time is added to time when the user enters the keystroke so that the active display remains active and therefore information relating to the number entered can not be determined by third parties overlooking the user or otherwise. The secure user interface contains one cycle for each digit of a user code. After entry of the entire user code the entered code is transmitted to the third computer for verification with a stored user code in the third computer.

The user code and the stored user code may just be a simple PIN, which is checked for one-to-one correspondence without the use of a mask code or security string.

Preferably, however, the user code is a mask code as hereinbefore defined, and the active display serves as an interface by which the user selects characters from a pseudo-random security string so as to generate a volatile one-time identification code also as hereinbefore defined, although the user will not be presented with the security string on-screen as before, selection of characters therefrom being hidden behind the interface.

The use of a user code entry interface (the “Pin Safe” interface”) has a number of advantages over the simple selection of characters from a security string displayed on-screen. Any device with a keyboard or touch sensitive interface which may be connected to a network or which is otherwise capable of downloading data or machine code may have the integrity of a password or key entry security system comprised. One way in which the system may be comprised is through the use of a Trojan program. A Trojan program is a small program which may collect keyboard information for latter use. An additional program can also collect password or key entry information but feigns an unsuccessful logon attempt at the last digit of the logon entry and attempts to continue the logon with the real user unaware, by guessing the last digit (this is known as a “sniffer” program). Both of these techniques require actual data from a device keyboard or key pad or other input device. Whereas data may, by encryption or other means, be delivered and resent securely right up to and from the actual process occurring in the devices processing unit, if the security system requires meaningful user data entry to access or operate the security system that data may be intercepted and relayed greatly reducing the security of the system.

Although keyboard or small amounts of other input data may be redirected or stored with little or no user indication or system performance impact the same cannot be said for the device's graphical display, where the output is high throughput and device specific. Screen grabbing, or screen capturing, is possible but system resource intensive and therefore quite likely to be discovered by a user, especially on a device of comparatively low processing power. A good level of resistance could therefore be offered by an interface that provides information to a security system that is only meaningful to that system within the scope of its own time interface parameters and where any captured keyboard information has no external meaning. Similarly, any possible screen grabbed or screen captured information should not compromise the system's logon security.

The inputting of a Usemame, Password or PIN number in a computer, PDA, 2.5 G or 3 G mobile device is currently flawed for the following reasons: (1) the user can be seen by onlookers entering his or her PIN number into the device (called ‘shoulder surfing’); (2) the keyboard could contain a ‘Trojan’ program that records the inputted Username, Password or PIN number (Trojans are downloaded without the knowledge of the user onto a computer and can reside there indefinitely); (3) PKI Certificates authenticate that the transaction was conducted on a certified computer, but they do not effectively authenticate the user behind the computer; and (4) computers running Microsoft Windows have a problem because Windows remembers the Usemame, Password or PIN number which creates a situation where the device stores the I/D of the User within the computer.

The Pin Safe user interface achieves a positive user identification because the user has to be present during every transaction. The Pin Safe user interface is Trojan resistant because any key can be used to input a PIN or volatile one-time identification code which renders any Trojan key intercept information useless, as does the displayed information on screen.

In addition, the user interface is shoulder surfing resistant because there is nothing that could be gleaned from looking either at the screen or the keyboard input, rendering shoulder surfing a pointless exercise. Further, the system is resistant to PIN interception when using the Dual and Single channel (Applet) protocol. The protocol of the present invention is unique because it transmits a volatile one-time identification code every time a transaction is made. A successful attempt to intercept/decrypt this information cannot result in the user's real PIN being compromised.

Alternative means for verifying the identities of the first and second users to the third computer may be employed, these means being generally known in the art.

It is to be appreciated that because the wrapped or encrypted data file is sent directly from the first computer to the second computer, for example as an e-mail attachment by way of the Internet, and at no time is sent to the third computer, there can be no possibility of the authorisation body or agency having access to the data file and thereby compromising its security. On the other hand, it is impossible for the second user, or any third party, to unwrap or decrypt the data file from within the executable file without the unique key code, which is effectively held in escrow by the third computer. The unique key code is only released to the second user by the third computer upon successful verification of the identity of the second user.

When the first user selects the second user as the recipient of the data file, the first user selects the permanent second user identification code for addressing purposes, possibly by way of selecting from a menu of users whose permanent identification codes have previously been registered with the authorisation body or agency. Selection of the second user's permanent identification code allows the wrapped or encrypted data file to be sent directly to the second user at the second computer by way of standard communications protocols, such as e-mail. This also allows the authorisation body or agency at the third computer to be informed by the first user that the data file has been sent to the second user, and allows the file name of the data file, the unique key code and the security string (in appropriate embodiments) to be correlated in the third computer with the identity of the second user by way of the second user's permanent identification code. This enables the third computer to ensure that the unique key code is only released to the second user and not to any other third party, since the second user must have his or her identity verified by the third computer before the unique key code is released. The permanent identification code of the first user is preferably also logged with the third computer together with the file name of the data file, the unique key code and the security string (where appropriate). In this way, it is possible to generate an audit trail at the third computer which can provide verification that the first user has sent the data file to the second user and that the second user has accessed and unwrapped or decrypted the data file, optionally including time and date information. This audit trail provides an independent verification of successful transmission and receipt, which may prove useful when embodiments of the present invention are used to send important data, such as legal summons, the receipt and access thereto by the second user needs to be confirmed.

Furthermore, by logging each transaction at the third computer together with the identities of the first and second users, it is possible for the authorisation body or agency to make a charge for the service provided and to bill the first and/or second users. It is envisaged that embodiments of the present invention will find especial utility for communications between lawyers and the like, and the use of transaction identifiers, e.g. case reference numbers, may allow periodic billings to be sent to each user or group of users, e.g. firms of lawyers, in a fully itemised format.

The first and second user volatile identification codes may be stored as digital signatures in the third computer in combination with the pseudo-random security string. The pseudo-random security string is preferably not stored in the third computer in a cleartext format for added security. The pseudo-random security string may also be used as a watermark (key source) for the wrapping/compression and encryption keys. A checksum algorithm may be employed to provide confirmation that the data file has been unwrapped or decrypted correctly in the second computer and also to ensure that the data file has not been modified in transit. Repeated attempts to access the wrapped or encrypted data file without the correct key code advantageously cause the wrapped or encrypted data file to be deleted from the second computer and cause a failure message to be transmitted from the second computer to the first and/or third computers.

According to a third aspect of the present invention, there is provided a method of transferring a data file to a first computer from a second computer, the method comprising the steps of:

i) establishing a communications link between the first and second computers;

ii) selecting, by way of the first computer, a data file for transfer from the second computer;

iii) in the second computer, wrapping or encrypting the data file within an executable file adapted to unwrap or decrypt the data file only upon activation by a unique key code, and then transmitting the executable file containing the wrapped or encrypted data file to the first computer;

iv) verifying an identity of a user of the first computer to the second computer by way of verification communications between the first and second computers;

v) upon successful verification of the user of the first computer, transmitting the unique key code to the first computer.

According to a fourth aspect of the present invention, there is provided a secure data transfer system comprising a first computer and a second computer, the system being adapted to transfer a data file to the first computer from the second computer, in which:

i) the first computer is adapted to establish a communications link with the second computer;

ii) the first computer is operable to select a data file for transfer from the second computer;

iii) the second computer is adapted to wrap or encrypt the data file within an executable file adapted to unwrap or decrypt the data file only upon activation by a unique key code, and to transmit the executable file containing the wrapped or encrypted data file to the first computer;

iv) the first and second computers are adapted to verify an identity of a user of the first computer by way of verification communications between the first and second computers;

v) the second computer is adapted, upon successful verification of the user of the first computer, to transmit the unique key code to the first computer.

The third and fourth aspects of the present invention may be implemented in the same manner as the first and second aspects, particularly with regard to the identity verification step.

Advantageously, upon transmittal of the unique key code to the first computer, the user of the first computer, who has been identified to the second computer, is billed or invoiced an amount of money for the data file. This invoicing is made possible because it is the user of the first computer, rather than the first computer per se, who is identified to the second computer, and the second computer may therefore issue an invoice or otherwise collect monies from the user of the first computer, possibly by way of a subscription account or otherwise.

According to a fifth aspect of the present invention, there is provided a method of transferring a data file to a first computer having a first telecommunications address from a second computer having a second telecommunications address, comprising the steps of:

i) transmitting a request for the data file from the first computer to the second computer, the request including data identifying the data file and the first telecommunications address;

ii) in the second computer, wrapping or encrypting the data file within an executable file adapted to unwrap or decrypt the data file only upon activation by a unique key code;

iii) assigning a unique identification string to the executable file in the second computer, the unique identification string being further associated in the second computer with the first telecommunications address;

iv) transmitting the executable file (containing the data file) and the unique identification string from the second computer to the first computer;

v) causing a message to be displayed by the first computer showing the unique identification string and requesting a user to call a predetermined telephone number from a telephone operated by the user;

vi) receiving a telephone call from the telephone operated by the user, determining its telephone number and receiving the unique identification string from the user;

vii) in the second computer, generating a pseudorandom string, associating the pseudorandom string with the unique identification string and the telephone number of the telephone operated by the user, and transmitting the pseudorandom string to the telephone operated by the user;

viii) applying a mask code, known to the user and to the second computer, to the pseudorandom identification string so as to generate a volatile identification code in accordance with predetermined rules;

ix) transmitting the volatile identification code to the second computer, either from the telephone operated by the user in which case the volatile identification code is transmitted together with the telephone number of the telephone operated by the user, or from the first computer in which case the volatile identification code is transmitted together with the first telecommunications address, the telephone number or the first telecommunications address respectively serving to identify the first computer, the user and the executable file;

x) in the second computer, checking that the volatile identification code matches a volatile identification code generated therein by applying the mask code to the pseudorandom string and, if so;

xi) transmitting the key code to the first computer so as to enable the executable file to unwrap or decrypt the data file and to install this on the first computer.

For the avoidance of doubt, the expressions “first computer” and “second computer” are not to be understood as being limited to first and second stand-alone computer devices, but are intended to encompass first and/or second computer networks, such as local or wide area networks and the like, as well as portable computers such as personal digital assistants and third (or subsequent) generation mobile telephones or communicators.

In the fifth aspect of the present invention, the second computer generally has stored therein a library of different data files, each of which may have a permanent identification code different from the unique identification string, which is individually generated for each executable file upon respective generation thereof. The permanent identification codes are provided so as to allow a user of the first computer to browse through the library of data files and to select data files for transmission. The library of data files may be remotely browsable from the first computer by way of a website or the like hosted by or otherwise linked to the second computer.

When the user has made his selection, for example by way of the website, selection information together with information identifying the first computer, for example an Internet Protocol (IP) address, is transmitted to the second computer. The second computer then wraps or encrypts the selected data file in the executable file in a manner which is known to those of ordinary skill in the art and assigns a unique identification string to the executable file. The unique identification string may include characters which identify the data file in a way which is meaningful to a human being. For example, where the data file is an MP3 audio file of a particular piece of music, the identification string may include characters which spell out a title of the piece of music. The unique identification string, in addition to identifying the executable file, also enables the second computer to identify the first computer and/or the user and/or the telephone operated by the user by correlating this data with the unique identification string in the second computer.

Instead of the second computer having stored therein the library of data files, the library of data files may be stored on and browsed by way of a third computer separate from the first and second computers. When a user makes a selection from the library, the third computer is then arranged to generate the unique identification string and to transmit this, together with the data file and the information identifying the first computer, such as an IP address, to the second computer by way of a telecommunications link. The data file is then wrapped or encrypted in the executable file at the second computer as discussed above.

Accordingly, a sixth aspect of the present invention provides a method of transferring a data file to a first computer having a first telecommunications address from a third computer having a third telecommunications address by way of a second computer having a second telecommunications address, comprising the steps of:

i) transmitting a request for the data file from the first computer to the third computer, the request including data identifying the data file and the first telecommunications address;

ii) transmitting the data file from the third computer to the second computer, together with the identification data from the request;

iii) in the second computer, wrapping or encrypting the data file within an executable file adapted to unwrap or decrypt the data file only upon activation by a unique key code;

iv) assigning a unique identification string to the executable file in the second computer, the unique identification string being further associated in the second computer with the first telecommunications address;

v) transmitting the executable file (containing the data file) and the unique identification string from the second computer to the first computer;

vi) causing a message to be displayed by the first computer showing the unique identification string and requesting a user to call a predetermined telephone number from a telephone operated by the user;

vii) receiving a telephone call from the telephone operated by the user, determining its telephone number and receiving the unique identification string from the user;

viii) in the second computer, generating a pseudo-random string, associating the pseudo-random string with the unique identification string and the telephone number of the telephone operated by the user, and transmitting the pseudo-random string to the telephone operated by the user;

ix) applying a mask code, known to the user and to the second computer, to the pseudo-random string so as to generate a volatile identification code in accordance with predetermined rules;

x) transmitting the volatile identification code to the second computer, either from the telephone operated by the user in which case the volatile identification code is transmitted together with the telephone number of the telephone operated by the user, or from the first computer in which case the volatile identification code is transmitted together with the first telecommunications address, the telephone number or the first telecommunications address respectively serving to identify the first computer, the user and the executable file;

xi) in the second computer, checking that the volatile identification code matches a volatile identification code generated therein by applying the mask code to the pseudo-random string and, if so;

xii) transmitting the key code to the first computer so as to enable the executable file to unwrap or decrypt the data file and to install this on the first computer.

The executable file and the unique identification string are then transmitted from the second computer to the first computer by way of a modem or Internet link or the like. When they arrive at the first computer, a message may be displayed so as to alert a user that the executable file and the unique identification string have arrived. In a preferred embodiment, the message prompts the user to make a telephone call to a predetermined telephone number, either by way of a landline telephone or, more preferably, by way of a mobile telephone. When the user calls the predetermined telephone number, the telephone number of the telephone operated by the user is automatically determined by known means and the user is then asked to give the unique identification string so as to enable the executable file to be correlated in the second computer with the telephone number of the telephone operated by the user.

In a particularly preferred embodiment, when the user calls the predetermined telephone number with details of the unique identification string, a charge is made to the user's telephone account in respect of the data file requested from the second computer. This charge can be collected by the provider of the data file by way of a prearranged contract with a telephone service provider to which the user subscribes. Charging protocols of this type are already known in relation to vending machines which may be operated by way of a mobile telephone, whereby a user makes a selection from the vending machine, calls a predetermined telephone number with details of his or her selection, and the vending machine is then activated to dispense the selection to the user while a charge is made to the user's telephone account so as to pay for the selection.

The second computer then generates a pseudorandom string, correlates this with the unique identification string (and thereby with the executable file and data identifying the user, e.g. the telephone number of the telephone operated by the user or the IP address of the first computer), and then transmits the pseudorandom string to the telephone operated by the user, for example by way of a short messaging service (SMS) message.

The user then applies the mask code, which in a preferred embodiment comprises the last four digits of the telephone number of the telephone operated by the user but which may comprise any predetermined combination of digits from the telephone number or another prearranged numerical string, to the pseudo-random string so as to generate a volatile identification code in accordance with predetermined rules, further details of which are provided below. The volatile identification code is then transmitted by the user to the second computer, either by way of, for example, an SMS message from the telephone operated by the user or by way of the first computer and an Internet or modem link. When transmitting the volatile identification code by either of these routes, further data identifying the user and hence the particular data file transaction is also transmitted so as to enable the second computer to identify the transaction to which the volatile identification code relates. These further data may comprise the telephone number of the telephone operated by the user or the IP address of the first computer, both of which are correlated in the second computer with the unique identification string and hence the particular transaction.

When the second computer receives the volatile identification code and the associated data identifying the transaction, it performs a check to see that the volatile identification code matches a volatile identification code generated independently in the second computer by applying the mask code to the pseudorandom string. If the volatile identification codes are found to match, safe receipt of the executable file is thereby confirmed to the second computer.

The second computer then transmits the key code to the first computer, generally by way of an Internet or modem link. Upon receipt of the key code at the first computer, the executable file is enabled so as to unwrap or decrypt the data file and to install this on the first computer for use by the user. The key code is preferably a unique code generated within the executable file when it is first compiled and distributed, but not transmitted therewith.

When the data file is installed on the first computer, the executable file may be adapted to install the data file only in a specific memory location within the first computer. For example, the executable file may ask the operating system of the first computer (e.g. DOS) for a free memory location (e.g. a diskvolume name) and any other necessary system parameter and will then install the data file to this memory location, generally in read-only format.

In a particularly preferred embodiment, the installation process at the first computer generates an electronic certificate which authenticates the origin of the data file and also registers the data file to the user. The electronic certificate may include details of, say, the IP address of the first computer, details identifying the data file and the memory location where it is stored in the first computer. The electronic certificate is displayed when the data file is first installed, and may also be displayed each subsequent time that the data file is opened by the user. It is preferred that the data file is stored at the memory location in a protected read-only format, and that it can only be opened from that memory location with simultaneous at least temporary display of the electronic certificate. In this way, the data file is protected from infection by viruses which may enter or be present in the first computer, since the data file is locked and owned by itself within the memory of the first computer.

The electronic certificate may also contain further details, such as a system time and date in real time when activated, various copyright identifiers and registered trade marks relating to the provider of the data file and/or the executable file, identification details of the first computer (such as its IP address) and identification details of the data file. Some or all of these details may be merged into a short animation watermark image (which may nominally be animated at a speed of 16 frames per second and shown for several seconds), and a sound file relating to the title of the data file may also be generated and activated upon opening the data file. The watermark image is difficult to recreate by counterfeit measures, and thereby helps to guarantee that the data file is from an authorised source, free from viruses and licensed to an authorised user. It is intended that the charge raised for use of the data file is low enough so as to make forgery of the electronic certificate not worthwhile.

Referring now to the mask code, this may take various forms. In a currently preferred embodiment, as previously described, a person is issued with or selects a four digit numerical string, for example 3928, analogous to the well-known PIN codes currently used when operating automated teller machines (ATMs). However, different lengths of mask code may be used as appropriate. In a particularly preferred embodiment, the mask code is based on the digits of the telephone number of the telephone from which the user calls the predetermined telephone number with details of the identification string and the volatile identification code. For example, the mask code may be set as the last four digits of the user's telephone number, say 3928.

In order to generate the volatile identification code, the user or the first or second computer takes the first digit of the mask code, in this example 3, and notes the character in third position (say from left to right) along the identification string. The user or computer then takes the second digit of the mask code, in this example 9, and notes the character in ninth position along the identification string, and so on for the digits 2 and 8 of the mask code. The characters selected from the identification string form the volatile identification code which is used for secure identification purposes. It is to be emphasised that the identification string assigned to the executable file by the second computer in response to a request for the data file will be different for each request, and that it will therefore be extremely difficult to determine a given mask code given a series of potentially interceptable identification strings and volatile identification codes.

### BRIEF DESCRIPTION OF THE DRAWINGS

For a better understanding of the present invention and to show how it may be carried into effect, reference shall now be made, by way of example, to the accompanying drawings in which:

FIG. 1 is a schematic representation of a first embodiment of the present invention;

FIG. 2 is a schematic representation of a second embodiment of the present invention;

FIG. 3 shows a display demonstrating a selection of a data file for transmission from a first computer;

FIG. 4 shows a secure user code entry interface displayed on the first computer;

FIG. 5 shows the secure user code entry interface of FIG. 4 after successful entry of a user code and PIN;

FIG. 6 shows a display on the first computer enabling a search to be made for a recipient of the data file;

FIG. 7 shows a display on the first computer giving results of a search for a recipient of the data file;

FIG. 8 shows a display on the first computer confirming that the data file has been transmitted to the recipient;

FIG. 9 shows a display on a second computer announcing receipt of the data file;

FIG. 10 shows a secure user code entry interface displayed on the second computer;

FIG. 11 shows the secure user code entry interface of FIG. 10 after successful entry of a user code and PIN;

FIG. 12 shows a display on the second computer confirming that the data file has been received and unwrapped;

FIG. 13 shows a display on the first computer confirming that the data file has been received at the second computer and successfully unpacked by a user of the second computer;

FIG. 14 is a flow diagram depicting a further embodiment of the present invention in accordance with the sixth aspect thereof;

FIG. 15 shows a user operating the first computer of the embodiment of FIG. 14;

FIG. 16 shows a display on the first computer offering a data file for transfer thereto;

FIG. 17 shows a display on the first computer prompting the user to call in with the unique identification string;

FIG. 18 shows the user calling in with the unique identification string;

FIGS. 19 and 20 show the pseudo-random string being transmitted to the user's telephone and illustrate the application of the mask code thereto so as to generate the volatile identification code;

FIG. 21 shows a display on the first computer prompting the user to input the volatile identification code;

FIG. 22 shows a display on the first computer as the executable file is being operated so as to unwrap or install the data file; and

FIG. 23 shows an electronic certificate displayed on the first computer when the data file has been unwrapped or installed.

### DETAILED DESCRIPTION OF THE PREFERRED EMBODIMENT

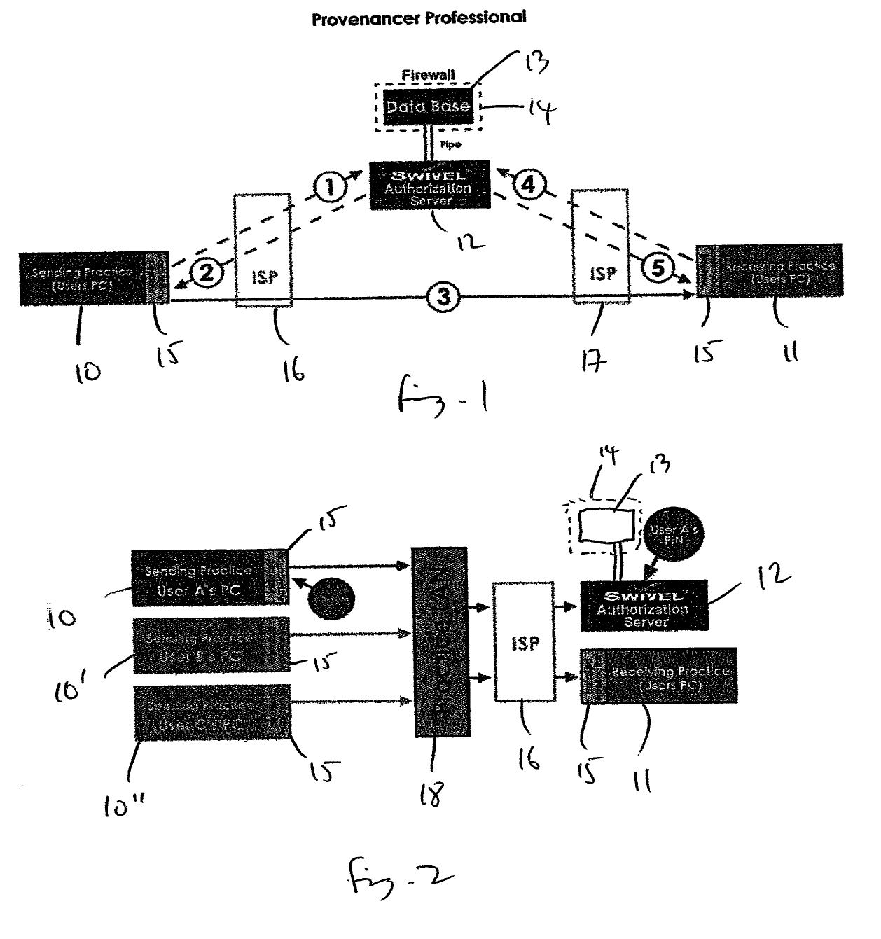

Referring firstly to FIG. 1, there is shown a general architecture of a first embodiment of the present invention, comprising a first computer 10, a second computer 11 and a third computer 12. The first and second computers 10, 11 may be stand-alone PCs, or may be PCs forming part of two separate LANs. The third computer 12 may be a remote server having access to a database 13 protected by a firewall 14. Each of the first and second computers 10, 11 has installed therein an application program 15 which is adapted to provide for secure identification of users of the first and second computers 10, 11 to the third computer 12, as will be described in more detail below. Identification information is communicated between the first computer 10 and the third computer 12 by way of telecommunications links 1, 2 via an Internet Service Provider (ISP) 16. Similarly, identification information is communicated between the second computer 11 and the third computer 12 by way of telecommunications links 4,5 via an Internet Service Provider (ISP) 17, which may or may not be the same ISP 16 as that connecting the first and third computers 10, 12. The application program 15 is adapted to transmit an encrypted or wrapped data file (not shown) from the first computer 10 directly to the second computer 11 (and bypassing the third computer 12) by way of ISP 16 and/or 17 and telecommunications link 3.

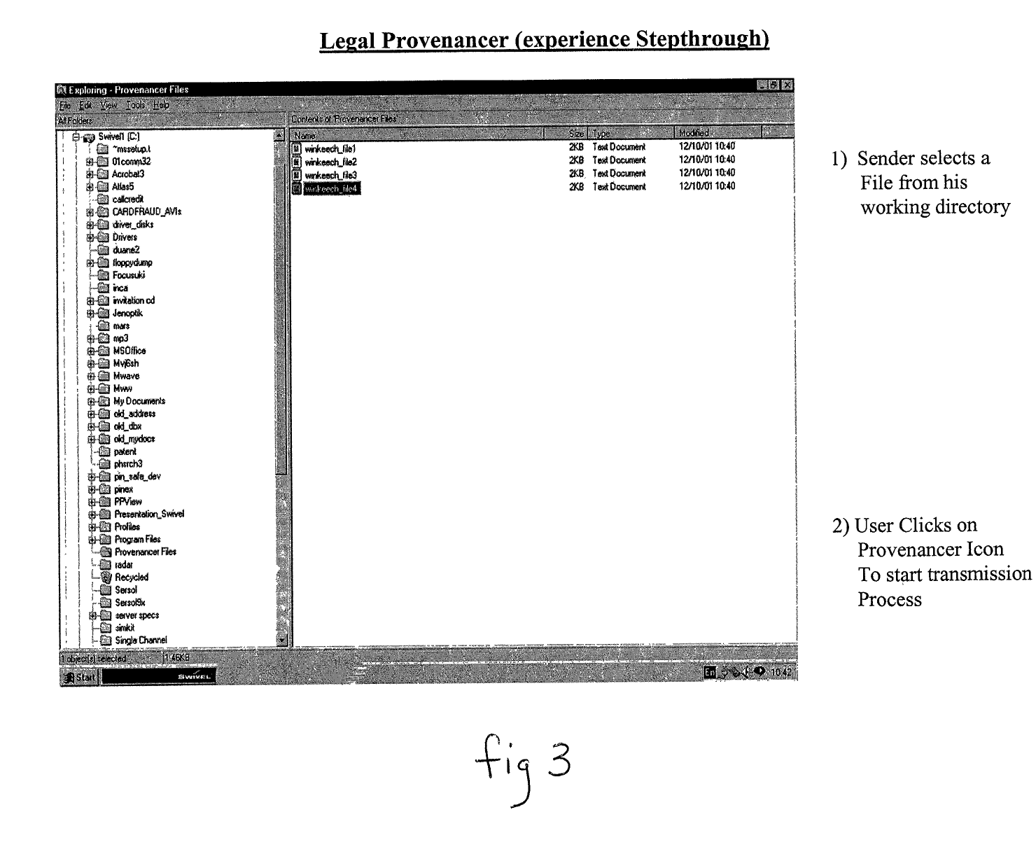

FIG. 2 shows an alternative architecture for the present invention, in which first computers 10, 10′ and 10″ are workstations within a first LAN 18, each of the first computers 10, 10′ and 10″ including an application program 15. Also shown is the third computer 12 including a database 13 protected by firewall 14, and the second computer 11. Identification information is exchanged between any of the first computers 10, 10′, 10″ forming the LAN 18 and the third computer 12, and also between the second computer 11 and the third computer 12, by way of ISP 16. The ISP 16 also serves to transfer an encrypted or wrapped data file (not shown) directly from a first computer 10, 10′, 10″ in the LAN 18 to the second computer 12, bypassing the third computer 12 entirely.

FIG. 3 shows a display on the first computer 10 comprising a directory listing 19 of files available for transfer to the second computer 11. One of the files 20 may be selected in a known manner and the application program 15 started by activating a button 21 in a task bar 22 of the display.

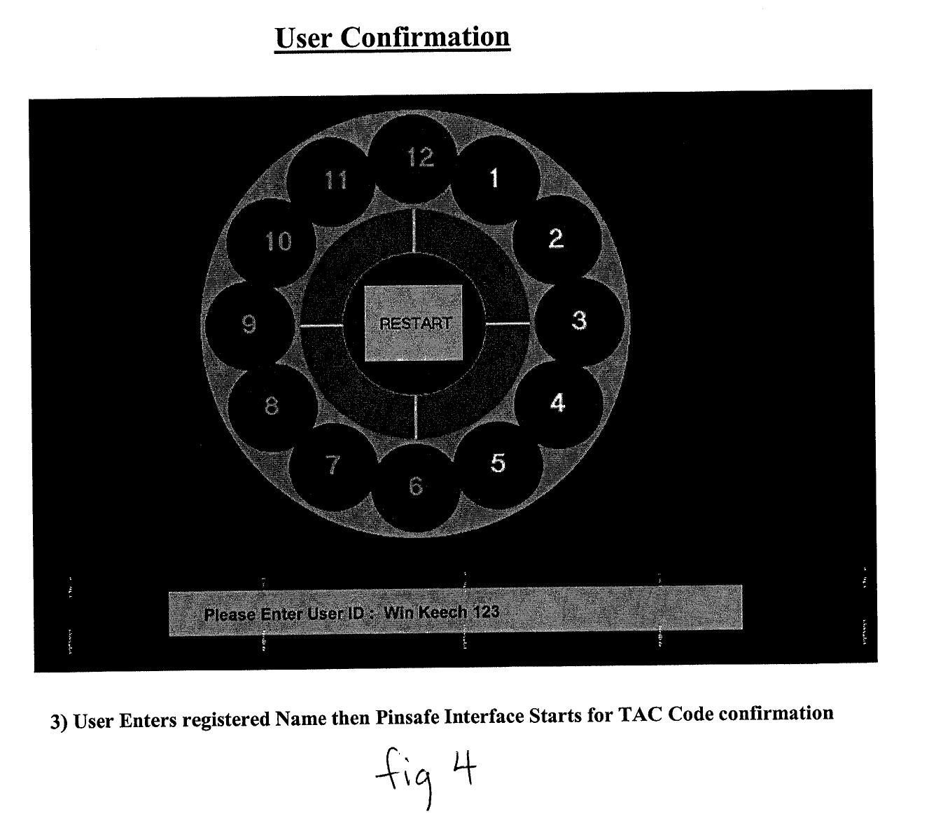

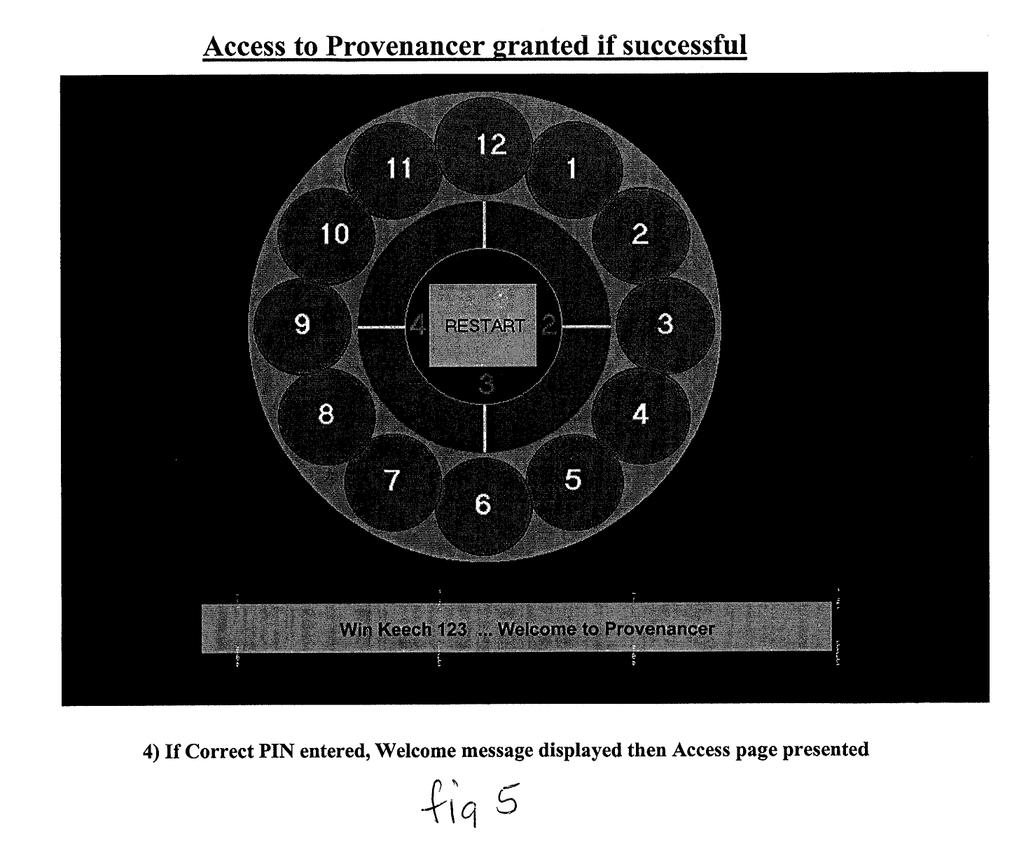

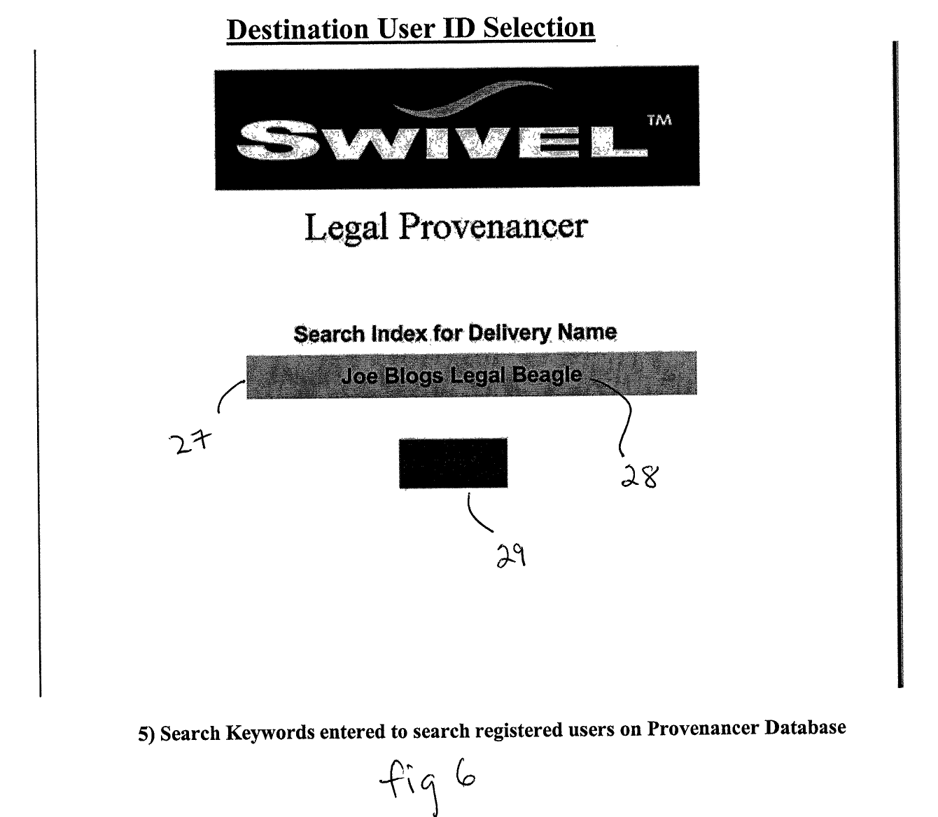

FIG. 4 shows a display on the first computer 10 after the application program 15 has been started. A user of the first computer 10 enters a unique first user identification code 23, in this case “Win Keech 123”. The user is in possession of a first user mask code (not shown), which is also stored securely on the third computer 12 in association with the unique first user identification code 23. A secure user code entry interface 24 is then activated sequentially to highlight digits 25 in the display and to detect a user input (e.g. activation of any key on a keyboard, a key on a mouse or a part of a touch-sensitive display) which is made when a digit 25 corresponding to a first digit in the first user mask code is highlighted, adding a random run on time before refreshing the display for entry of the second, third and fourth (and optionally subsequent) digits of the first user mask code. Each selection of a digit 25 corresponding to a digit of the first user mask code results in selection of a character of a pseudo-random security string which is either generated in the first computer 10 or transmitted thereto by the third computer 12, the selection of characters from the pseudo-random security string comprising a first user volatile identification code which is then transmitted to the third computer 12. The first user volatile identification code generated by way of the secure user code entry interface 24 and transmitted to the third computer 12 is then checked in the third computer 12 to see if it matches a first user volatile identification code generated independently in the third computer 12 by applying the first user mask code to the pseudo-random security string in the third computer 12. If the first user is thus correctly identified to the third computer 12, the display causes a welcome message 26 to be displayed, as shown in FIG. 5.

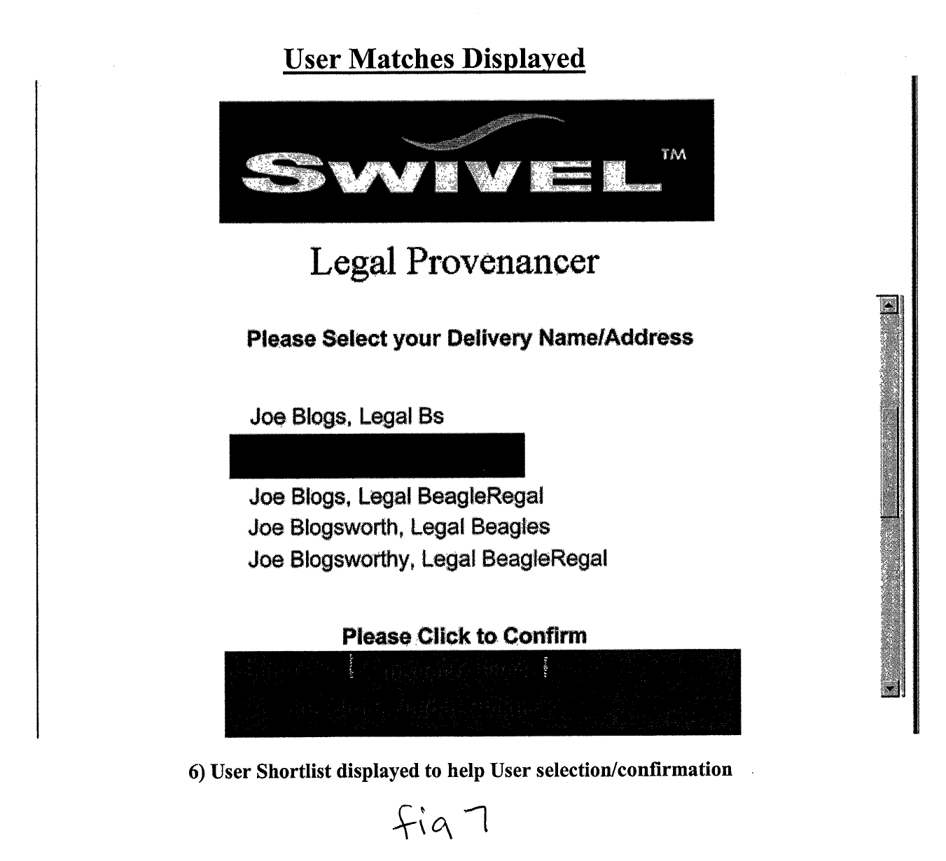

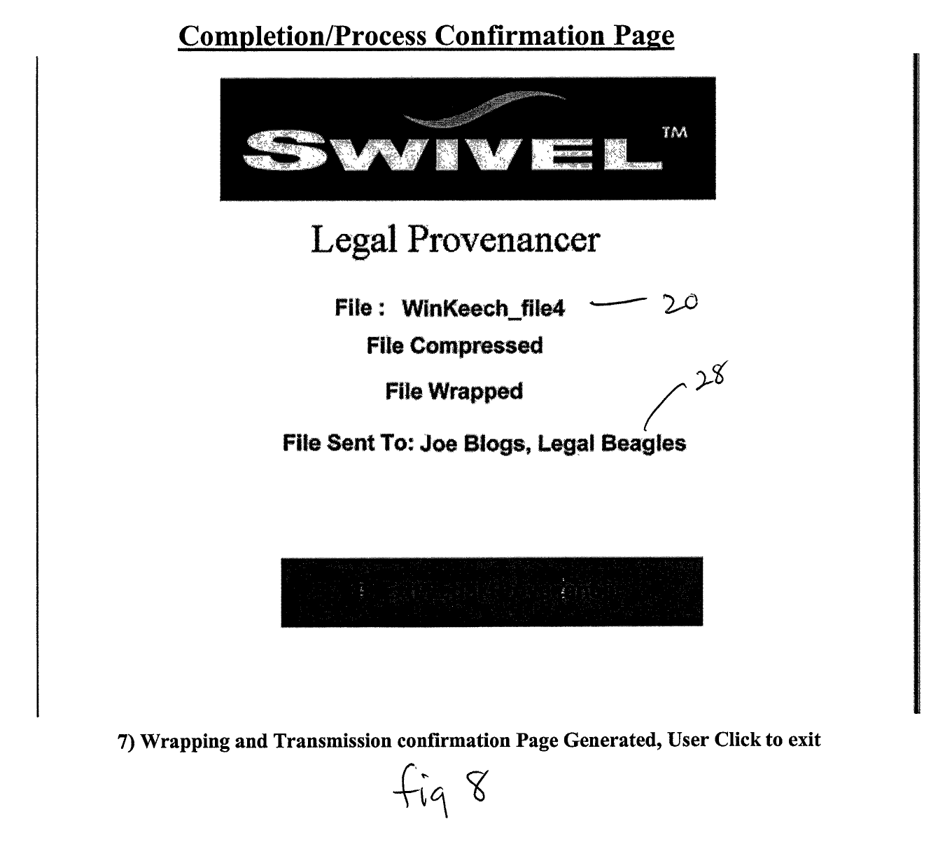

Once the first user has been identified to the third computer 12, he or she is prompted to select a recipient for the data file 20, this recipient being the second user in the language of the present application. FIG. 6 shows a display including a field 27 for input of a unique permanent second user identification code or synonym thereto 28. When the input is made by pressing a “go” button 29, a menu 30 of possible recipient/second user identities is displayed, and the correct unique permanent second user identification code or synonym 28 may be selected from the menu 30 and confirmed by way of a dialogue box 31 as shown in FIG. 7.

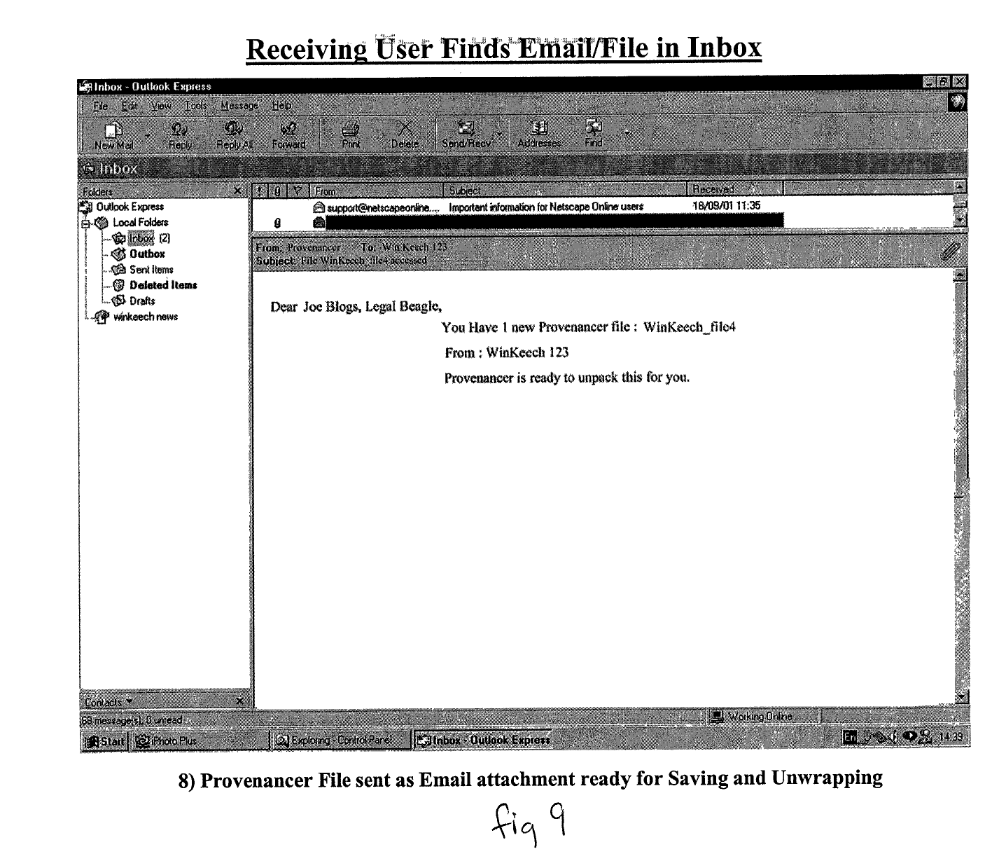

Meanwhile, the data file 20 is wrapped, compressed and/or encrypted in the first computer 10 by the application program 15 within an executable file (not shown) which is transmitted directly to the second computer 11 by way of telecommunications link 3 (see FIG. 1), for example, while a unique key code (not shown) generated by the application program 15 and required by the second computer 11 to access the data file 20 is sent directly to the third computer 12 by way of telecommunications link 1 (see FIG. 1), for example. FIG. 8 shows a confirmation display on the first computer 10 including fields identifying the data file 20 and the permanent second user identification code 28. The file name of the data file 20 and the permanent second user identification code 28 are also sent by the first computer 10 to the third computer 12 by way of telecommunications link 1 together with the unique key code, where they are also associated with the permanent first user identification code 23.

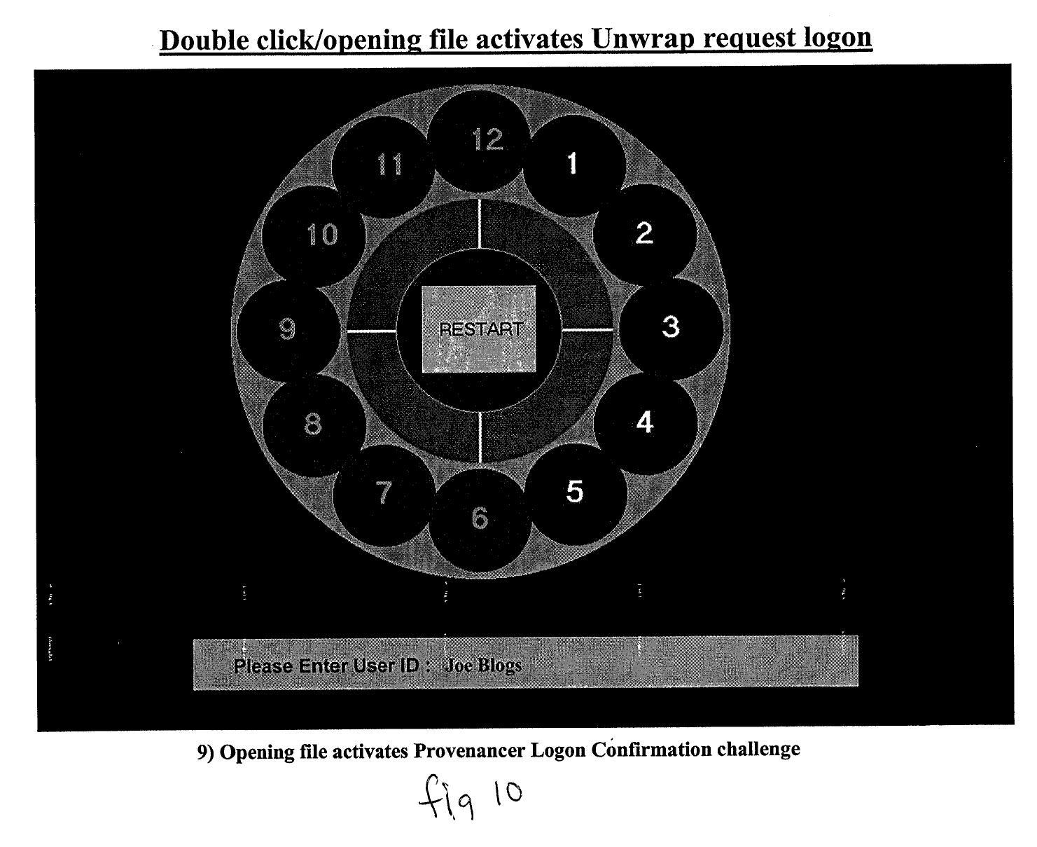

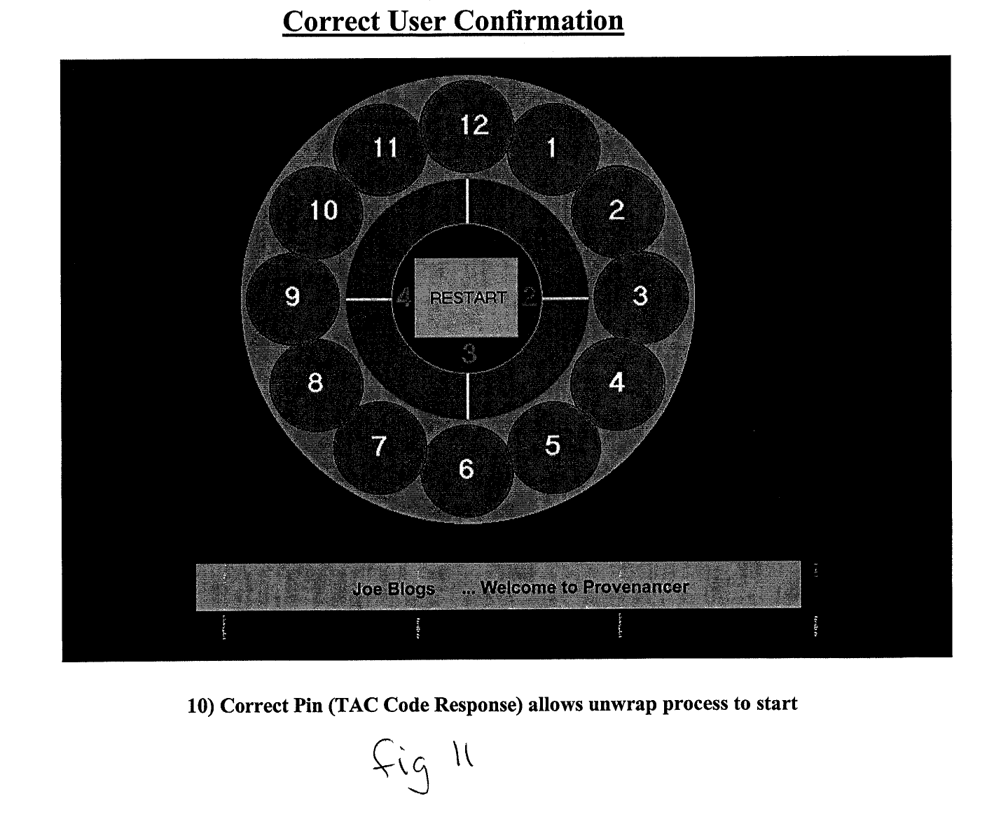

FIG. 9 shows a display on the second computer 11 indicating receipt of an e-mail communication 32 having the executable file attached thereto as an attachment 33. The e-mail 32 is received directly from the first user of the first computer 10, and the permanent first user identification code 23 and the name of the data file 20 are displayed in the e-mail 32. When the second user attempts to access the attachment 33, this causes the application program 15 resident on the second computer 11 to start and to display a secure user code entry interface 24′, as shown in FIG. 10.

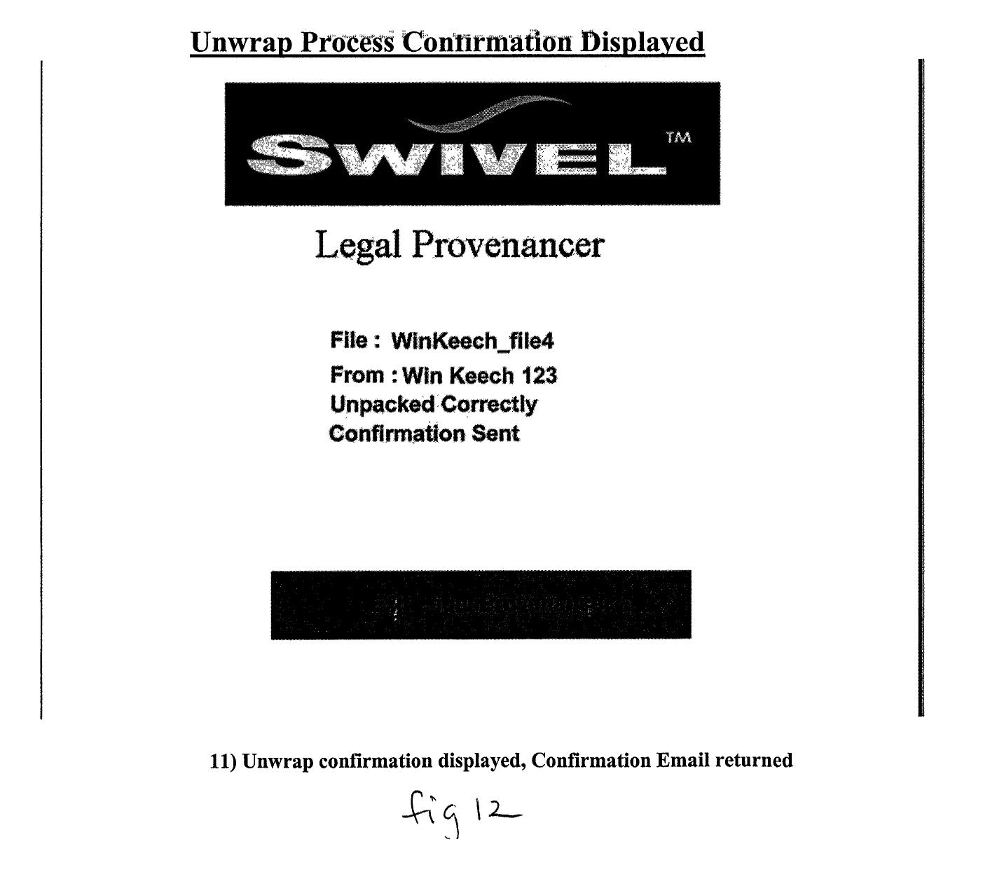

The secure user code entry interface 24′ of FIG. 10 is substantially identical to the secure user code entry interface 24 of FIG. 4, and allows the identity of the second user of the second computer 11 to be verified to the third computer 12. Specifically, the second user enters his or her permanent second user identification code 28 and is then prompted, by way of sequential highlighting of digits 25′ in the interface 24′, to enter his or her second user mask code (not shown) in the same manner as described above in relation to the first user. The interface 24′ applies the second user mask code to the pseudo-random security string transmitted by the first or third computer 10, 12 so as to generate a second user volatile identification code (not shown) which is then transmitted to the third computer 12 for comparison with a second user volatile identification code (not shown) generated independently in the third computer 12 by applying the second user mask code to the pseudo-random security string. If the volatile identification codes are found to match, a welcome message 26′ is displayed, as shown in FIG. 11.

FIG. 12 shows a display on the second computer 11 confirming that the data file 20 received from the first user having a permanent first user identification code 23 has been unwrapped and decrypted, and that a confirmation message indicating receipt of and access to the data file 20 by the second user has been sent to the first and/or third computer 10, 12. A checksum algorithm may be used to check correct receipt of the data file 20 in an uncorrupted form.

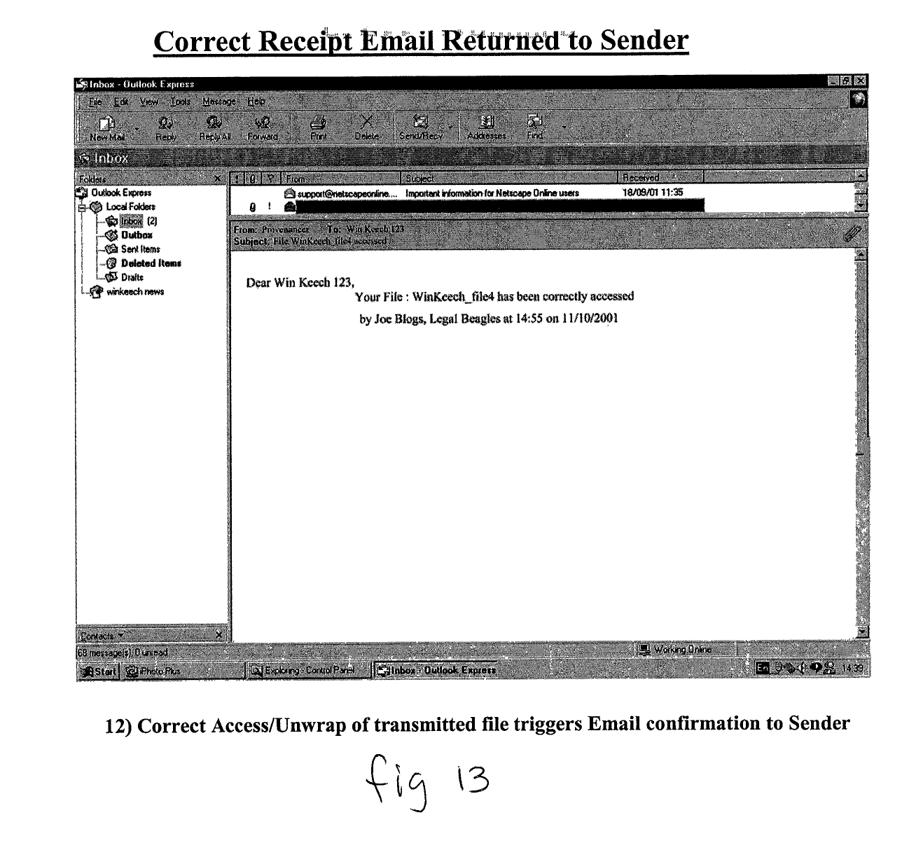

FIG. 13 shows a display on the first computer 10 confirming receipt of the confirmation message from the second computer 11 in the form of an e-mail 34. The e-mail 34 includes a message that the data file 20 has been correctly accessed by the second user, identified by the permanent second user identification code 28, on a given time and date 35. This information may be sent separately to the third computer 12 and stored therein as part of an audit trail allowing later confirmation of successful transfer of the data file 20.

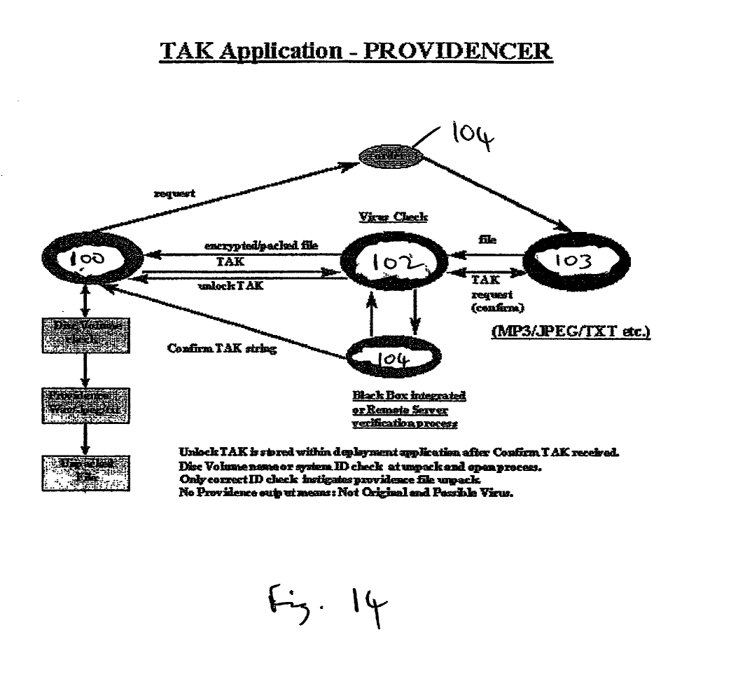

FIG. 14 shows an alternative architecture relating particularly to the sixth aspect of the present invention. There is shown a first computer 100 and a second computer 102. The second computer 102 has access to a database held on a third computer 103 (which may be a separate third computer or may instead form part of the second computer 102). Communication between a user of the first computer 100 and the second computer 102 is additionally enabled by way of a telephone link 104 permitting voice and/or SMS text message exchange.

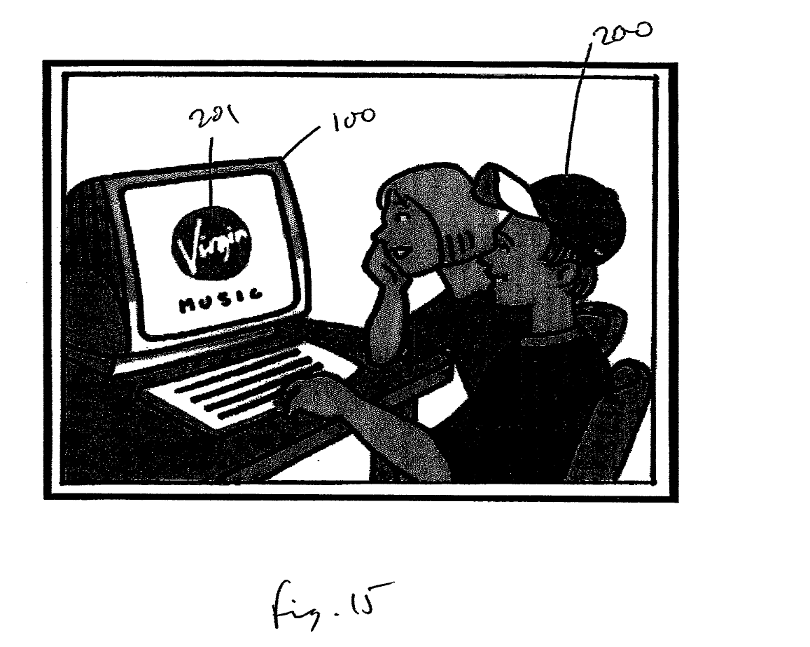

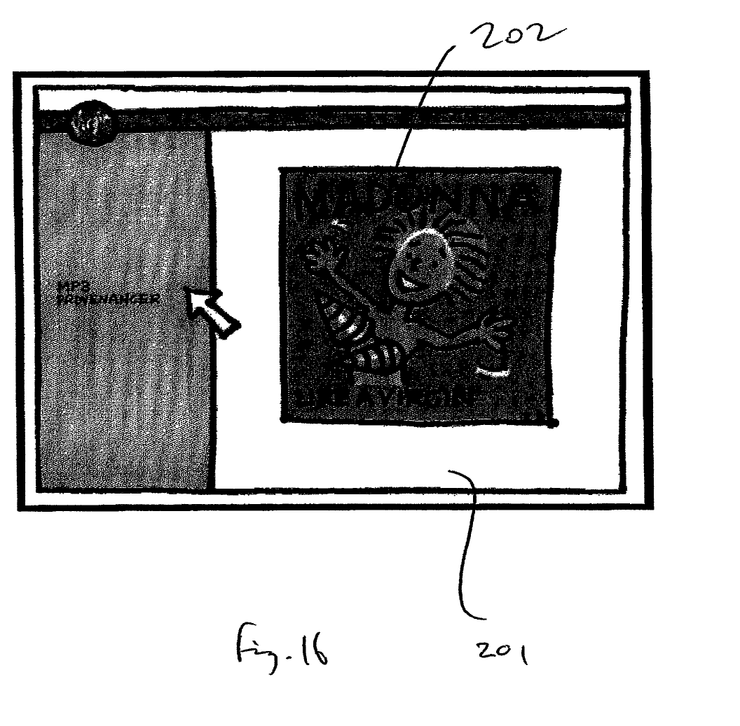

In operation, a user 200 (FIG. 15) of the first computer 100 browses a selection of data files stored on the third computer 103, possibly by way of a Website 201 (FIG. 16) or the like hosted by the third computer 103, and requests a data file 202 for transfer at step 104 of FIG. 14. The data file 202 may be a sound, graphics or video file, for example in MP3, MPEG, JPEG, .wav formats etc. or any other type of file. The request for the data file 202 includes data identifying the data file, together with a telecommunications address of the first computer.

The third computer 103 then transmits the data file 202, together with the telecommunications address of the first computer 100, to the second computer 102, where the data file 202 is wrapped and/or encrypted within an executable file as previously described, and a unique key code (for unwrapping and/or decrypting the data file from within the executable file) is generated. The second computer 102 may also perform a virus scan on the data file 202 to check that it is free from viruses, worms or Trojans, before transmitting the executable file to the first computer 100 together with an associated unique identification string 203 associated with the data file.

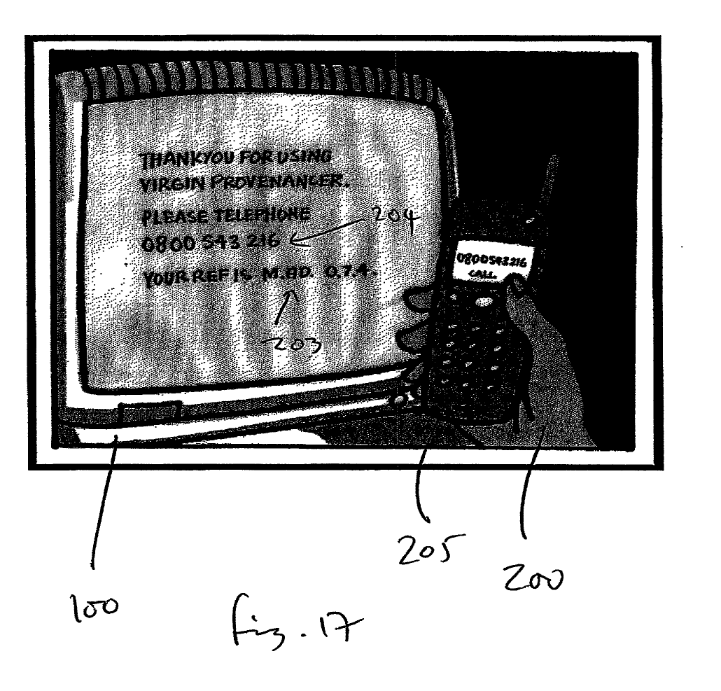

When the data file 202 is received by the first computer 100, a message is displayed on the first computer 100 showing the unique identification string 203 and requesting the user 200 to call a predetermined telephone number 204 by way of a telephone 205 operated by the user 200, as shown in FIG. 17. The predetermined telephone number 204 connects the user 200 to an operator of the second computer 102.

The user 200 then calls the predetermined telephone number 204 and gives the unique identification string 203 to the operator of the second computer 102. In addition, the telephone number of the telephone 205 operated by the user 200 is captured and stored in the second computer 102.

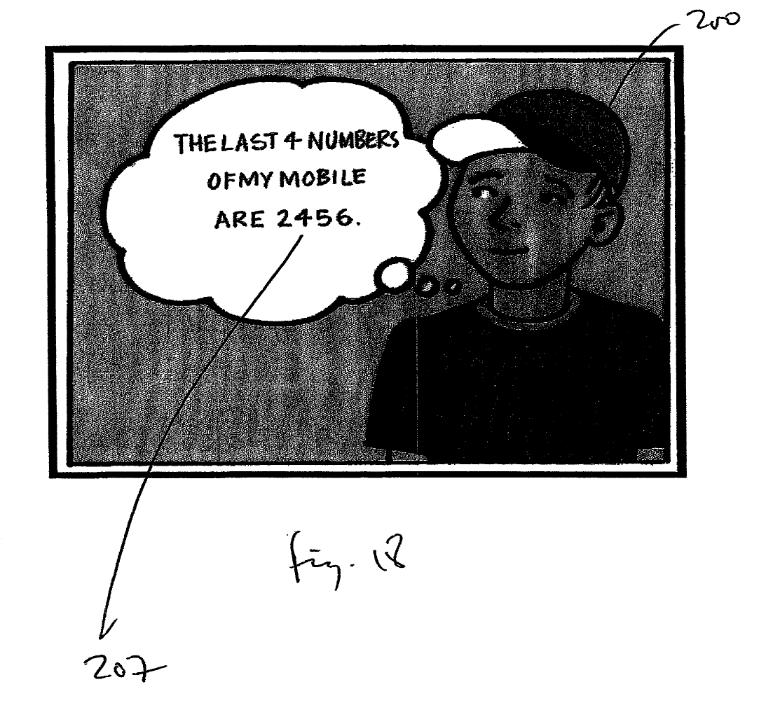

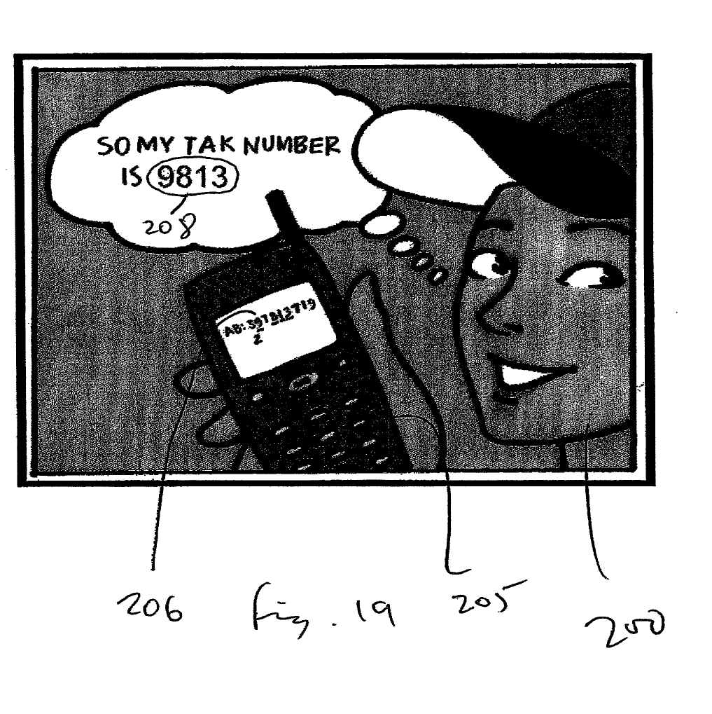

The second computer 102 then generates a pseudo-random security string 206 (see FIG. 19) and transmits this by way of an SMS text message to the telephone 205. The user 200 applies a mask code 207 (see FIG. 18) comprising the last four digits of the telephone number of the telephone 205 to the pseudo-random string 206 so as to generate a volatile identification code 208 as previously described and as shown in FIG. 19.

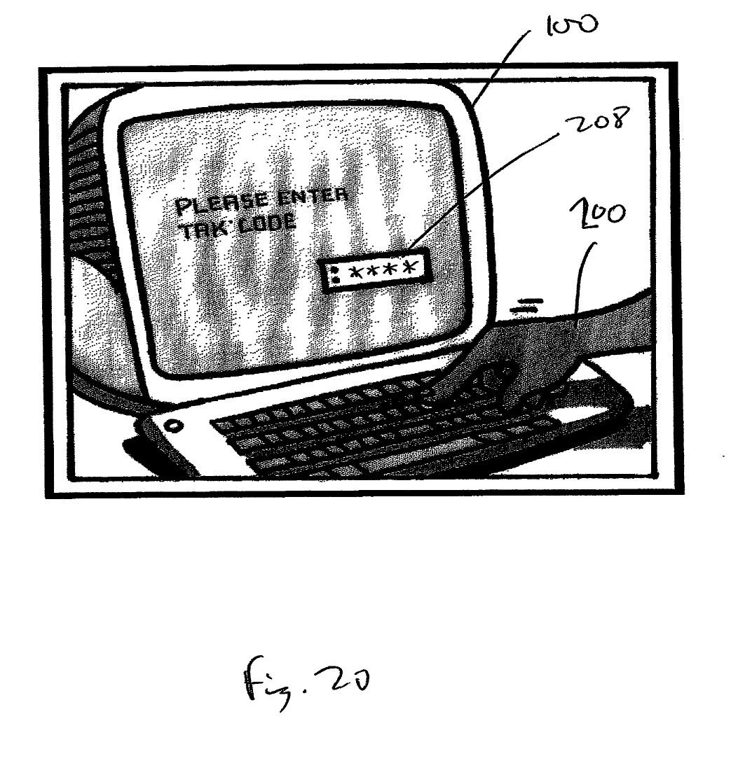

The user 200 then transmits the volatile identification code 208 to the second computer 102, either by inputting the volatile identification code 208 into the first computer 100 and transmitting it to the second computer 102 as shown in FIG. 20, or by way of an SMS text message sent from the telephone 205.

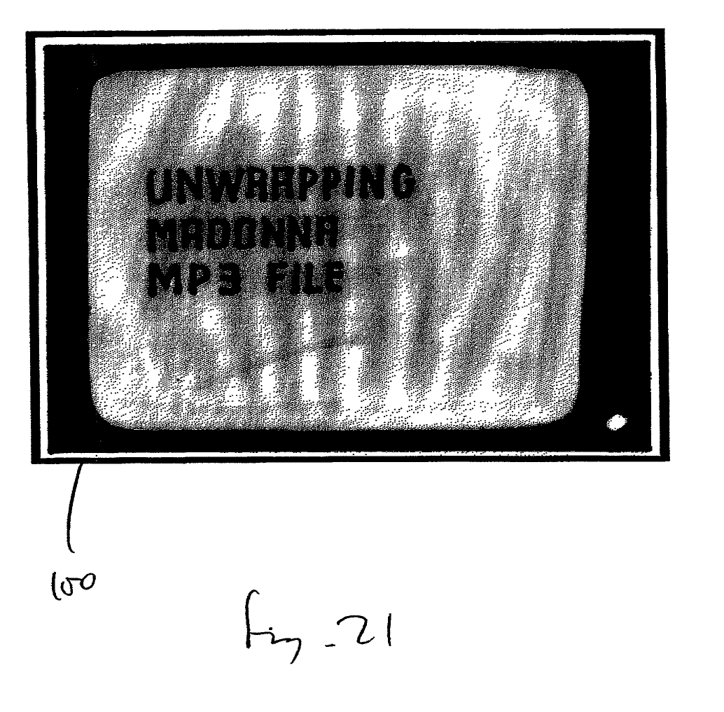

The second computer 102 then checks the volatile identification code 208 received from the user 200 against a check volatile identification code independently generated in the second computer 102 by applying the mask code 207 to the pseudo-random security string 206. If the volatile identification codes match, the user 200 is considered to have been identified to the second computer 102 and the unique key code is then transmitted from the second computer 102 to the first computer 100 so as to allow the data file 202 to be unwrapped and/or decrypted in the first computer 100, as shown in FIG. 21.

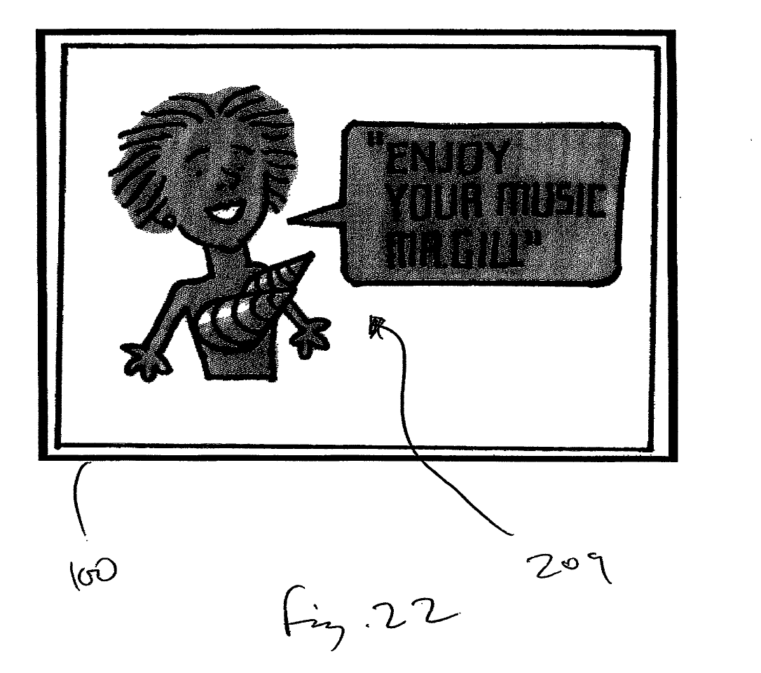

Finally, the data file 202 is installed on the first computer 100 so as to allow the user 200 access thereto. An animated electronic certificate 209 may be displayed on the first computer 100, as shown in FIG. 22, when the data file 202 is installed and upon each subsequent access to the data file 202.

1. A method of transferring a data file having a file name from a first computer operated by a first user to a second computer operated by a second user, under control of a third computer, comprising the steps of:
i) in the first computer, the first user selecting a data file for transfer and establishing a communications link with the third computer;
ii) verifying an identity of the first user to the third computer by way of verification communications between the first and third computers;
iii) in the first computer, wrapping or encrypting the data file within an executable file adapted to unwrap or decrypt the data file only upon activation by a unique key code, and then transmitting the executable file containing the wrapped or encrypted data file directly to the second computer together with first user identification information and the file name of the data file;
iv) transmitting the file name of the data file from the first computer to the third computer, together with first user identification information and the unique key code;
v) in the second computer, upon receipt of the executable file containing the wrapped or encrypted data file and upon attempted access thereto by the second user, establishing a communications link with the third computer;
vi) verifying an identity of the second user to the third computer by way of verification communications between the second and third computers;
vii) upon successful verification of the identity of the second user, transmitting the file name of the data file from the second computer to the third computer with a request for the unique key code; and
viii) transmitting the unique key code from the third computer to the second computer so as to cause the executable file to unwrap or decrypt the data file and to allow access thereto in the second computer by the second user.

2. A method according to claim 1, wherein the identity of the first user is verified in step ii) above by way of the first user applying a first user mask code to a pseudo-random security string in the first computer so as to generate a first user volatile identification code, the first user transmitting the first user volatile identification code to the third computer and the third computer comparing the first user volatile identification code with a first check volatile identification code obtained by applying the first user mask code to the pseudo-random string in the third computer, identity verification taking place when the first user volatile identification code and the first check volatile identification codes are found to match each other.

3. A method according to claim 1, wherein the identity of the second user is verified in step vi) above by way of the second user applying a second user mask code to a pseudo-random security string in the second computer so as to generate a second user volatile identification code, the second user transmitting the second user volatile identification code to the third computer and the third computer comparing the second user volatile identification code with a second check volatile identification code obtained by applying the second user mask code to the pseudo-random string in the third computer, identity verification taking place when the second user volatile identification code and the second check volatile identification codes are found to match each other.

4. A method according to claim 3, wherein the first user mask code and the second user mask code are applied to the same pseudo-random security string.

5. A method according to claim 4, wherein the pseudo-random string is generated by the third computer and transmitted firstly to the first computer and then from the first computer to the second computer.

6. A method according to claim 4, wherein the pseudo-random string is generated by the third computer and transmitted firstly to the first computer and then from the third computer to the second computer.

7. A method according to claim 3, wherein the first user mask code and the second user mask code are applied to different pseudo-random security strings.

8. A method according to claim 1, wherein the identity of the first or second user is verified, respectively, through said first or second computer by way of a secure user code entry interface for entry of a user mask code by way of the computer and a display; wherein:
i) said secure user code entry interface contains at least one active display for entry of at least one digit of said user mask code by the user; wherein said active display illuminates or highlights at least one display digit within said active display and said user enters said at least one digit of said user mask code by a response through an input device at a response time when said at least one display digit which corresponds with said at least one digit of said user mask code is illuminated or highlighted in said active display; and
ii) a random run on time is added to said response time to extend said at least one active display.

9. A method according to claim 2, wherein:
i) the pseudo-random string comprises a first linear array of characters, each character having a given numerical position in the first array (first, second, third etc.);
ii) the mask code comprises a second linear array of numbers, each number having a given numerical position in the second array (first, second, third etc.); and
iii) the volatile identification code is generated by applying the mask code to the pseudo-random string so as sequentially to select numerical positions in the first array on the basis of the numbers in the second array, taken in positional order, and to return the characters thereby selected from the first array in sequence so as to form a third linear array, this third linear array forming the volatile identification code.

10. A method according to claim 1, wherein the third computer maintains a record of transactions between the first, second and third computers so as to permit an audit trail to be established.

11. A method according to claim 2, wherein the first and/or second user volatile identification codes are stored as digital signatures in the third computer in combination with the associated pseudo-random security string.

12. A method of transferring a data file to a first computer from a second computer, the method comprising the steps of:
i) establishing a communications link between the first and second computers;
ii) selecting, by way of the first computer, a data file for transfer from the second computer;
iii) in the second computer, wrapping or encrypting the data file within an executable file adapted to unwrap or decrypt the data file only upon activation by a unique key code, and then transmitting the executable file containing the wrapped or encrypted data file to the first computer;
iv) verifying an identity of a user of the first computer to the second computer by way of verification communications between the first and second computers;
v) upon successful verification of the user of the first computer, transmitting the unique key code to the first computer.

13. A method according to claim 12, wherein the identity of the first user is verified in step iv) above by way of the first user applying a first user mask code to a pseudo-random security string in the first computer so as to generate a first user volatile identification code, the first user transmitting the first user volatile identification code to the second computer and the second computer comparing the first user volatile identification code with a first check volatile identification code obtained by applying the first user mask code to the pseudo-random string in the second computer, identity verification taking place when the first user volatile identification code and the first check volatile identification codes are found to match each other.

14. A method according to claim 12, wherein the identity of the first user is verified through said first computer by way of a secure user code entry interface for entry of a user mask code by way of the computer and a display; wherein:
i) said secure user code entry interface contains at least one active display for entry of at least one digit of said user mask code by the user; wherein said active display illuminates or highlights at least one display digit within said active display and said user enters said at least one digit of said user mask code by a response through an input device at a response time when said at least one display digit which corresponds with said at least one digit of said user mask code is illuminated or highlighted in said active display; and
ii) a random run on time is added to said response time to extend said at least one active display.

15. A method according to claim 13 or any claim depending therefrom, wherein:
i) the pseudo-random string comprises a first linear array of characters, each character having a given numerical position in the first array (first, second, third etc.);
ii) the mask code comprises a second linear array of numbers, each number having a given numerical position in the second array (first, second, third etc.); and
iii) the volatile identification code is generated by applying the mask code to the pseudo-random string so as sequentially to select numerical positions in the first array on the basis of the numbers in the second array, taken in positional order, and to return the characters thereby selected from the first array in sequence so as to form a third linear array, this third linear array forming the volatile identification code.

16. A method of transferring a data file to a first computer having a first telecommunications address from a second computer having a second telecommunications address, comprising the steps of:
i) transmitting a request for the data file from the first computer to the second computer, the request including data identifying the data file and the first telecommunications address;
ii) in the second computer, wrapping or encrypting the data file within an executable file adapted to unwrap or decrypt the data file only upon activation by a unique key code;
iii) assigning a unique identification string to the executable file in the second computer, the unique identification string being further associated in the second computer with the first telecommunications address;
iv) transmitting the executable file (containing the data file) and the unique identification string from the second computer to the first computer;
v) causing a message to be displayed by the first computer showing the unique identification string and requesting a user to call a predetermined telephone number from a telephone operated by the user;
vi) receiving a telephone call from the telephone operated by the user, determining its telephone number and receiving the unique identification string from the user;
vii) in the second computer, generating a pseudo-random string, associating the pseudo-random string with the unique identification string and the telephone number of the telephone operated by the user, and transmitting the pseudo-random string to the telephone operated by the user;
viii) applying a mask code, known to the user and to the second computer, to the pseudo-random identification string so as to generate a volatile identification code in accordance with predetermined rules;
ix) transmitting the volatile identification code to the second computer, either from the telephone operated by the user in which case the volatile identification code is transmitted together with the telephone number of the telephone operated by the user, or from the first computer in which case the volatile identification code is transmitted together with the first telecommunications address, the telephone number or the first telecommunications address respectively serving to identify the first computer, the user and the executable file;
x) in the second computer, checking that the volatile identification code matches a volatile identification code generated therein by applying the mask code to the pseudo-random string and, if so;
xi) transmitting the key code to the first computer so as to enable the executable file to unwrap or decrypt the data file and to install this on the first computer.

17. A secure data transfer system comprising a first computer operated by a first user, a second computer operated by a second user and a third computer, the system being adapted to transfer a data file having a file name from the first computer to the second computer under control of the third computer, in which:
i) the first computer is adapted to establish a communications link with the third computer upon selection by the first user of a data file for transfer;
ii) the first and third computers are adapted to verify an identity of the first user to the third computer by way of verification communications between the first computer and the third computer;
iii) the first computer is adapted to wrap or encrypt the data file within an executable file adapted to unwrap or decrypt the data file only upon activation by a unique key code, and to transmit the executable file containing the wrapped or encrypted data file directly to the second computer together with first user identification information and the file name of the data file;
iv) the first computer is adapted to transmit the file name of the data file from the first computer to the third computer, together with first user identification information and the unique key code;
v) the second computer is adapted, upon receipt of the executable file containing the wrapped or encrypted data file and upon attempted access thereto by the second user, to establish a communications link with the third computer;
vi) the second and third computers are adapted to verify an identity of the second user to the third computer by way of verification communications between the second computer and the third computer;
vii) the second computer is adapted, upon successful verification of the identity of the second user, to transmit the file name of the data file from the second computer to the third computer with a request for the unique key code; and
viii) the third computer is adapted to transmit the unique key code from the third computer to the second computer so as to cause the executable file to unwrap or decrypt the data file and to allow access thereto in the second computer by the second user.

18. A system as claimed in claim 17, adapted such that the identity of the first user is verified in step ii) above by way of the first user applying a first user mask code to a pseudo-random security string in the first computer so as to generate a first user volatile identification code, the first user transmitting the first user volatile identification code to the third computer and the third computer comparing the first user volatile identification code with a first check volatile identification code obtained by applying the first user mask code to the pseudo-random string in the third computer, identity verification taking place when the first user volatile identification code and the first check volatile identification codes are found to match each other.

19. A system as claimed in claim 18, adapted such that the identity of the second user is verified in step vi) above by way of the second user applying a second user mask code to a pseudo-random security string in the second computer so as to generate a second user volatile identification code, the second user transmitting the second user volatile identification code to the third computer and the third computer comparing the second user volatile identification code with a second check volatile identification code obtained by applying the second user mask code to the pseudo-random string in the third computer, identity verification taking place when the second user volatile identification code and the second check volatile identification codes are found to match each other.

20. A system as claimed in claim 19, adapted such that the first user mask code and the second user mask code are applied to the same pseudo-random security string.

21. A system as claimed in claim 20, adapted such that the pseudo-random string is generated by the third computer and transmitted firstly to the first computer and then from the first computer to the second computer.

22. A system as claimed in claim 20, adapted such that the pseudo-random string is generated by the third computer and transmitted firstly to the first computer and then from the third computer to the second computer.

23. A system as claimed in claim 19, adapted such that the first user mask code and the second user mask code are applied to different pseudo-random security strings.

24. A system as claimed in claim 17, adapted such that the identity of the first or second user is verified, respectively, through said first or second computer by way of a secure user code entry interface for entry of a user mask code by way of the computer and a display; wherein:
i) said secure user code entry interface contains at least one active display for entry of at least one digit of said user mask code by the user; wherein said active display is adapted to illuminate or highlight at least one display digit within said active display and said interface is adapted to allow said user to enter said at least one digit of said user mask code by a response through an input device at a response time when said at least one display digit which corresponds with said at least one digit of said user mask code is illuminated or highlighted in said active display; and
ii) a random run on time is added to said response time to extend said at least one active display.

25. A system as claimed in claim 18, wherein:
i) the pseudo-random string comprises a first linear array of characters, each character having a given numerical position in the first array (first, second, third etc.);
ii) the mask code comprises a second linear array of numbers, each number having a given numerical position in the second array (first, second, third etc.); and
iii) the volatile identification code is generated by applying the mask code to the pseudo-random string so as sequentially to select numerical positions in the first array on the basis of the numbers in the second array, taken in positional order, and to return the characters thereby selected from the first array in sequence so as to form a third linear array, this third linear array forming the volatile identification code.

26. A system as claimed in claim 17, wherein the third computer is adapted to maintain a record of transactions between the first, second and third computers so as to permit an audit trail to be established.

27. A system as claimed in claim 18, wherein the third computer is adapted to store said first and/or second user volatile identification codes as digital signatures in combination with the associated pseudo-random security string.
